(19) United States
(12) Patent Application Publication
(10) Pub. No.: US 2017/0127122 A1
(43) Pub. Date: May 4, 2017

(54) DIGITAL VIDEO BROADCASTING NETWORK SYSTEM AND METHOD OF OBTAINING PROGRAM INFORMATION IN DIGITAL VIDEO BROADCASTING

(71) Applicant: THOMSON LICENSING, Issy-les-Moulineaux (FR)

(72) Inventor: Yonggang WANG, BEIJING (CN)

(21) Appl. No.: 15/318,666

(22) PCT Filed: Jun. 13, 2014
(86) PCT No.: PCT/CN2014/079831

§ 371 Date: Dec. 13, 2016

(51) Int. Cl. H04N 21/434; H04N 21/262; H04N 21/8547; H04N 21/61

(52) U.S. Cl. CPC H04N 21/4345; H04N 21/6125; H04N 21/26291; H04N 21/8547

(57) ABSTRACT

A digital video broadcasting network system includes a program information server to deliver program information by using Internet Protocol, and a client device to obtain and save the program information through the Internet Protocol. The program information server delivers the program information including a program information version indicating a version status of the program information and a program information map including a set of information records used to allow the client device to identify a program to be delivered at the version status and to reproduce the program, and updates the program information depending on a version change of the version status. The client device updates currently saved program information when a version status included in the currently saved program information is different from the version status of the delivered program information, by obtaining the program information delivered from the program information server.

### TECHNICAL FIELD

The present invention relates to a digital video broadcasting network system and a method of obtaining program information in digital video broadcasting.

### BACKGROUND ART

There is a DVB (Digital Video Broadcasting) service that has been developed as an internationally accepted open standard for digital television. As disclosed in United States Patent Application Publication No. 2007/0101389 A1, a DVB-H (Digital Video Broadcasting-Hand held) service utilizes PSI (Program Specific Information), which is metadata about a program and part of an MPEG (Moving Picture Experts Group) transport stream. The PSI as defined by ISO/IEC 13818-1 includes four tables of PAT (Program Association Table), CAT (Conditional Access Table), PMT (Program Map Table) and NIT (Network Information Table). Hence, the PSI is transmitted in the form of a table structure.

However, when the PSI is transmitted in the form of the table structure, a client device such as a set top box and a digital television needs to have a filter to identify each table of the PSI and a function to analyze each table. This makes the structure of the client device complicated to reproduce and play the program from the PSI.

### SUMMARY

Accordingly, embodiments of the present invention may provide a novel and useful digital video broadcasting network system and a method of obtaining program information in digital video broadcasting solving one or more of the problems discussed above.

More specifically, the embodiments of the present invention may provide a digital video broadcasting network system and a method of obtaining program information in digital video broadcasting that can directly obtain necessary information from a memory of a client device without filtering and analyzing a PSI table sent from a DVB server.

According to an embodiment of the present invention, there is provided a digital video broadcasting network system including a program information server configured to deliver program information by using Internet Protocol, and a client device configured to obtain and save the program information through the Internet Protocol. The program information server delivers the program information including a program information version indicating a version status of the program information and a program information map including a set of information records used to allow the client device to identify a program to be delivered at the version status and to reproduce the program, and updates the program information depending on a version change of the version status. The client device updates currently saved program information when a version status included in the currently saved program information is different from the version status of the delivered program information, by obtaining the program information delivered from the program information server as new program information.

According to an embodiment of the present invention, there is provided a method of obtaining program information in digital video broadcasting. In the method, program information is delivered from a program information server to a client device through Internet protocol. The program information includes a program information version indicating a version status of the program information and a program information map including a set of information records used to allow the client device to identify a program to be delivered at the version status and to reproduce the program. The program information is updated depending on a version change of the version status at the program information server. Currently saved program information is updated at the client device when a version status included in the currently saved program information of the client device is different from the version status of the delivered program information, by obtaining the program information delivered from the program information server as new program information.

Other objects, features, and advantages of the present invention will become more apparent from the following detailed description when read in conjunction with the accompanying drawings.

### BRIEF DESCRIPTION OF THE DRAWINGS

FIG. 1 is a block diagram illustrating an example of a cable DVB network according to an embodiment of the present invention;

FIG. 2 is a block diagram illustrating an example of a Set Top Box (STB) according to an embodiment of the present invention;

FIG. 3 is a partial block diagram illustrating an example of a program information server according to an embodiment of the present invention; and

FIG. 4 is a sequence diagram for explaining how to obtain a program information version and a program information map at a client according to an embodiment of the present invention.

### DESCRIPTION OF EMBODIMENTS

A description is given below of embodiments of the present invention, with reference to the drawings.

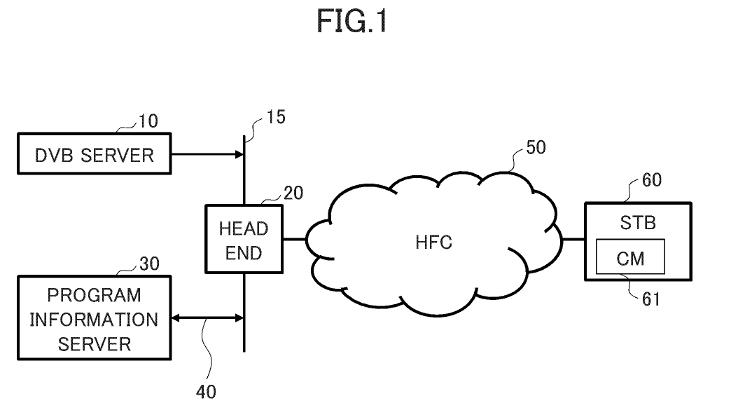

FIG. 1 is a block diagram illustrating an example of a cable DVB network system according to an embodiment of the present invention. This invention is used in bidirectional DVB network systems, such as a cable DVB network system with DOCSIS (Data Over Cable Service Interface Specifications) support. It would also run on combined networks of IP (Internet Protocol) and DVB, such as combined terrestrial and IP networks.

In FIG. 1, a DVB server 10 is connected to a head end system 20 through a cable 15. A program information server 30 is connected to the head end through an IP network 40. Hence, the head end system 20 is connected to the DVB server 10 through the cable 15 and to the program information server 30 through the IP network 40. The head end system 20 is connected to a STB 60 through an HFC (Hybrid Fiber Coax) 50. Accordingly, both the DVB server 10 and the program information server 30 are connected to the STB 60 by way of the head end system 20 and the HFC 50. The HFC is one of the cables used for configuring a CATV (Cable television) network, and is constituted by combining an optical fiber and a coaxial cable. In general, one end of the STB 60 is connected to a television (which is not shown in FIG. 1) to enable the television to receive various services such as digital television program services, the Internet services, data communication services and the like, and the other end of the STB 60 is connected to the CATV network, which is the HFC 50 in FIG. 1. The STB 60 is connected to the HFC 50 through a cable modem 61 that enables the STB 60 to perform data communication through the CATV network, the HFC 50 in FIG. 1. Here, the cable modem 61 may be incorporated in the STB 60, as illustrated in FIG. 1.

The DVB server 10 is a server to provide a DVB service for client devices such as a set top box and a digital television. In FIG. 1, the STB 60 corresponds to one of the client devices.

The head end system 20 is a master facility for receiving television signals for processing and distribution over the CATV network, and is installed in a CATV station. Also, the head end system 20 includes a computer system to communicate with the program information server 30 through the IP network 40. For example, the head end system 20 includes a cable modem termination system (CMTS) to send and receive digital cable modem signals on the CATV network and to provide the Internet services to the client devices such as the STB 60. In FIG. 1, the head end system 20 is illustrated between the DVB server 10 and the program information server 30, but the head end system 20 may be configured to include the DVB server 10 and the program information server 30 as a whole as necessary.

The program information server 30 is a server to deliver program information to the client devices such as the STB 60. The program information at least includes a program information version and a program information map. The program information version indicates a version status of the program information. The program information map includes a set of information records used to allow the client device to identify a program to be delivered at the version status indicated by the program information version and to reproduce and play the program. A more detailed description is given later with respect to contents of the program information and a way of handling the program information.

In ISO/IEC 13818-1, PSI is to be delivered from the DVB server 10 to the STB 60. As discussed above, the PSI includes four tables to be filtered and analyzed by the clients such as the STB 60 to reproduce and play the program contents. This makes it difficult to reproduce and play the program contents.

In the embodiment of the present invention, program information is delivered from the program information server 30 to the STB 60. The data transfer is based on the Internet Protocol such as the IP network 40 in FIG. 1. The network system according to the embodiment of the present invention needs the cable modem 61 or another IP device to support the data transfer based on the IP.

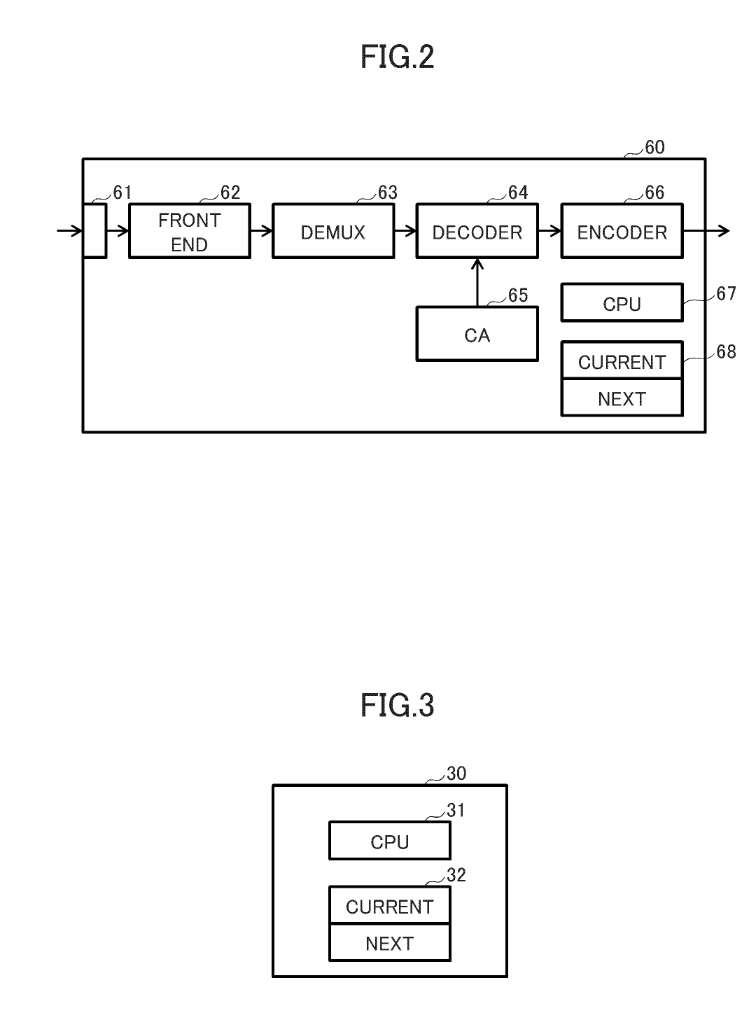

FIG. 2 is a block diagram illustrating an example of a Set Top Box (STB) according to an embodiment of the present invention. The STB 60 includes the cable modem 61, a front end 62, a demultiplexer (which is hereinafter called “a demux”) 63, a decoder 64, a Conditional Access (CA) module (which is hereinafter called “a CA module”) 65, an encoder 66, a CPU (Central Processing Unit) 67, and a memory 68.

The front end 62 is a component to directly receive and send data from and to the head end system 20 through the cable modem 61. The demux 63 divides a video signal into an image signal and a sound signal and outputs the image signal and the sound signal as separate signals, respectively. The decoder 64 performs the reverse operation of an encoder, undoing the encoding so that the original information can be retrieved. The CA module 65 is an electronic device, usually incorporating a slot for a smart card, which equips the STB 60 with the appropriate hardware facility to view conditional access content that has been encrypted using a conditional access system (which is not shown in the drawing). The encoder 66 encodes the data from the decoder 64 into a form appropriate for the connected television (which is not shown in the drawing). The CPU 67 reads and writes the data in the memory 68. The memory 68 stores various kinds of data. In the embodiment of the present invention, the memory 68 saves program information of a current version and a next version delivered from the program information server 30. In this regard, a more detailed description is given later.

To play a program, the STB 60 should get information from the head end system 20 to make STB hardware work properly. The key information is needed for the front end 62, the demux 63 and the CA module 65 to make the STB hardware work properly.

In the embodiment of present invention, the PSI table is not used to transfer these pieces of information. These pieces of information are transferred by using an IP package. The IP package includes a set of information records used to make the STB 60 work properly. Moreover, the information is transferred by IP packets as a form of data transmission. TABLE 1 is an example of the key information for the cable STB 60. The key information includes necessary information to make the STB 60 work properly. However, some accessorial information could also be used, such as a program name.

TABLE 1

```
Front End Parameters:
            Frequency, Symbol rate, QAM mode
Demux Parameters:
            Video PID, Audio PID
CA parameters:
            CA descriptor, EMM PID, ECM PID
```

TABLE 1 illustrates front end parameters used for the front end 62, demultiplexer parameters (which is hereinafter called “demux parameters”) used for the demux 63, and Conditional Access parameters (which is hereinafter called “CA parameters”) used for the CA module 65. The front end parameters, the demux parameters and the CA parameters are necessary parameters to make the front end 62, the demux 63 and the CA module 65 work properly in order to identify the program information to be played and to reproduce and play the program.

More specifically, for example, as illustrated in TABLE 1, the front end parameters include parameters of a frequency, a symbol rate and a QAM (Quadrature Amplitude Modulation) mode that relate to tuning the program. Similarly, the demux parameters include parameters of a video PID (Packet Identifier) and an audio PID that relate to determining which packets are part of the current program being watched and whether to pass the packets onto the decoder 64 for further processing. The CA parameters include parameters of a CA descriptor, an EMM (Entitlement Management Message) PID and an ECM (Entitlement Control Massage) PID that relate to a CA system to control subscriber access to services, programs and events.

By using these parameters to allow the STB 60 to identify the program information to be reproduced and to reproduce and play the program, the STB 60 can reproduce and play the program without using the PSI including the four tables of the PAT, CAT, PMT and NIT. This serves to make the structure of the STB 60 simple.

These parameters have to include at least necessary information to allow the STB 60 to identify the program information to be reproduced and to reproduce and play the program, but may include desirable information in addition to the necessary information if desired.

Moreover, the parameters may be arbitrarily select depending on the characteristics of the client device such as the STB 60 and intended use.

Next, a description is given below of a format of the program information. In the embodiment of the present invention, a Program Information Version (which is hereinafter called a “PIV”) and a Program Information Map (which is hereinafter called a “PIM”) are defined as program information components to transfer all of the program information. The program information delivered from the program information server 30 includes both the PIV and the PIM.

TABLE 2 illustrates an example of the PIV and the PIM.

TABLE 2

| PIV format: | | |
|---|---|---|
| Timestamp | | |
| PIM format: | | |
| Checksum | Length | Network type |

| | | | | |
|---|---|---|---|---|
| ID | Program Name | FE para | Demux para | CA para |
| ID | Program Name | FE para | Demux para | CA para |
| ID | Program Name | FE para | Demux para | CA para |
| . . . | | | | |

The PIV is information about a version status of the program information. As illustrated in TABLE 2, the PIV may be expressed by a timestamp. The timestamp means the time when the PIM is effective (valid). The timestamp could be GPS (Global Positioning System) time or UTC (Coordinated Universal Time). The PIM is a set of program information records including the front end parameters, the demux parameters and the CA parameters that are discussed above. One PIV works together with one PIM. In other words, a pair of the PIV and the PIM constitutes the program information.

Because parameters vary from network to network, a “Network type” field is used to analyze the parameters structure in the PIM in the embodiment. A “Checksum” field and a “Length” field are used to check data integrity. The data integrity is checked during network transfer and local saving.

Moreover, in TABLE 2, an “ID” and a “Program Name” are used as the accessorial information as discussed above.

In this manner, the program information delivered from the program information server 30 includes the PIV indicating the version status and the PIM including the set of information records used to allow the STB 60 to play the program.

Next, a description is given below of a program information update by using the program information having the above-mentioned format.

Two versions of the PIV and the PIM are used for the program information update. One version is a current version, another is a next version. The timestamp in a current PIV should be a past time. This means that the PIM has been effective (valid). The timestamp in a next PIV should be a future time. It means the PIM will be effective in the future.

In FIG. 2, the STB 60 includes the memory 68, in which both of the current version and the next version of the pair of the PIV and the PIM can be saved, respectively. In this manner, the STB 60 is configured to be able to save the program information of both the current version and the next version. In addition, the CPU 67 accesses the PIV and the PIM to delete and update the PIV and the PIM of any of the current version and the next version.

FIG. 3 is a partial block diagram illustrating an example of the program information server 30. As illustrated in FIG. 3, the program information server 30 includes a CPU 31 and a memory 32. In the memory 32, both of the current version and the next version of the PIV and the PIM can be saved similarly to the memory 68 of the STB 60. Moreover, the program information server 30 can update the program information (including the pair of PIV and PMV) of any of the current version and the next version by the CPU 31. For example, the program information server 30 updates the PIV and the PIM depending on the update information or instruction sent through the head end system 20. The original update information or instruction may be sent from the DVB server 10, the head end system 20 or another unit. Furthermore, the program information server 30 may update the PIV and the PIM by itself without receiving any update instruction from another unit.

Thus, the program server 30 and the STB 60 are configured to store and update the PIV and the PIM of both the current version and the next version.

The system time is received from the head end system 20 according to Network Time Protocol (NTP). If the system time reaches the timestamp of the next PIV, the current PIV and PIM are discarded, and the next PIV and PIM become the current PIV and PIM. There are no next PIV and PIM in the STB 60 at this time. When the program information is updated by the program information server 30, the STB 60 resets all of the parameters for currently saved program information.

If there are no valid current PIV and PIM saved in the STB 60, the STB 60 must request information about the current PIV and PIM from the head end system 20 at once. Otherwise, the STB 60 requests the information about the current PIV and PIM only when the STB 60 initializes the data of its own.

If the next PIV is undefined or 0 at the program information server 30, that means there is no next PIM in the system.

Here, in the conventional technique, the head end system 20 has to perform very complex operations. There are many servers that come from different vendors. Some servers may not perform real-time operation. It is difficult to synchronize program information among all of the servers. The two-version program information mechanism of the embodiment of the present invention provides a low cost solution to solve the synchronization issue. For example, when an administrator announces that a new version of program information becomes effective in 20 hours, there is enough time for all of the servers to synchronize with this information. The administrator would set the PIM effective time at midnight. Most users are unlikely to notice the glitch for audio and video contents caused by the program information update.

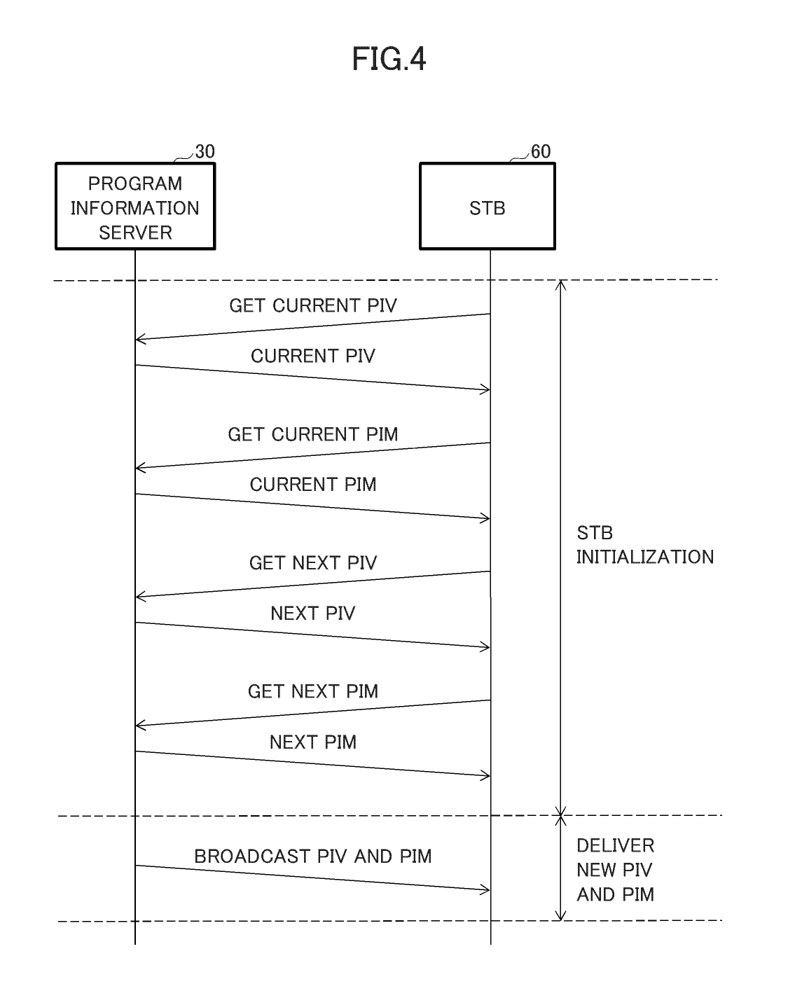

FIG. 4 is a sequence diagram for explaining how to obtain the PIV and PIM. After the STB 60 is powered on or reset, the STB 60 logs in to the head end system 20. Then the STB 60 gets an address of the program information server 30 and requests a current PIV from the program information server 30 by way of the HFC 50, the head end system 20 and the IP network 40. Here, the head end system 20 relays the request to the program information server 30 through the IP network 40. The program information server 30 sends the current PIV of the current status in the memory 32 by using the IP network 40, and the STB 60 receives the current PIV from the program information server 30. When the current PIV obtained from the program information server 30 is the same as a currently saved PIV of the STB 60, there is no need to update the current PIV and PIM. When the current PIV is different from the current PIV saved in the STB 60, the STB 60 requests a current PIM from the program information server 30. The program information server 30 sends the current PIM to the STB 60 through the IP network 40 in response to the request. Upon receiving the current PIM from the program information server 30, the STB 60 saves the PIV and PIM as the current version in the memory 68.

Then the STB 60 requests a next PIV from the program information server 30. If the next PIV is undefined or 0, that means there is no next PIM in the system. When the next PIV is valid and different from the PIV currently saved in the memory 68 of the STB 60, the STB 60 requests the next PIM from the program information server 30. After receiving the next PIM from the program information server 30, the STB 60 saves the next PIV and PIM as the next version.

If a system administrator updates the PIM, the system broadcasts new PIM and PIV to the network. All working STBs 60 get the data. The Server-Sent Events mechanism in HTML5 could be used to support this feature. If the timestamp in the PIV is past time at the STB 60, the STB 60 must update the current PIV and PIM, and then reset all parameters for the current program. If the timestamp in PIV is future time, the STB 60 saves the PIV and PIM as the next version. The saved PIV and PIM pair is still effective to cover the old saved value for next version.

Although the STB 60 is used as the client device in the embodiments, a variety of devices are available for the client device as long as the client device can receive and reproduce the digital video broadcasting program from Transport Stream. For example, a digital television is also available for the client device.

As described above, according to a digital video broadcasting network system and a method of obtaining program information in digital video broadcasting of the embodiments of the present invention, a STB gets PIV and PIM from an IP package and saves the PIV and PIM in a memory of its own. When a user zaps to a program, there is no need to filter and analyze a PSI table. The STB would get all information from its own memory directly.

More specifically, there is no need to includes DVB stack in the STB. The STB software would be simple.

There is no standard difference for different regions. For example, the difference between ETSI EN300468 for Europe and SCTE-65 for North America does not affect functions of the digital video broadcasting network system and the method of obtaining program information in digital video broadcasting of the embodiments of the present invention. The same software would run on the hardware for North America and on the hardware for Europe.

There is no need to filter and analyze the PSI table. This can save zapping time. In the conventional PSI solution, the STB needs to filter and analyze NIT, PAT, PMT and CAT tables. These tables use a data carousel to transfer the data. The STB must wait until getting the table, which wastes time. This is one of the reasons that the zapping slows. The digital video broadcasting network system and the method of obtaining program information in digital video broadcasting of the embodiments of the present invention solve this issue.

For a headend system, there is no need to create and insert the PSI into Transport Stream. This would save costs and bandwidth for the head end system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention. Although the embodiments of the present invention have been described in detail, it should be understood that various changes, substitutions, and alterations could be made hereto without departing from the spirit and scope of the invention.

1-8. (canceled)

9. A method of obtaining program information in digital video broadcasting, the method comprising, at a client device:
receiving program information from a program information server through Internet protocol, the program information including a program information version indicating a version status of the program information and a program information map including a set of information records used to allow the client device to identify a program to be delivered at the version status and to reproduce the program;
updating currently saved program information at the client device when a version status included in the currently saved program information of the client device is different from the version status of the delivered program information, by obtaining the program information delivered from the program information server as new program information.

10. The method as claimed in claim 9, further comprising:
retaining the currently saved program information at the client device when the version status included in the currently saved program information is the same as the version status of the delivered program information.

11. The method as claimed in claim 10,
wherein the version status includes a current version and a next version,
wherein the updating of the program information depending on a version change of the version status at the program information server is performed by updating the program information from the current version to the next version as time passes with respect to both the program information version and the program information map, and
wherein the updating of the currently saved program information at the client device and retaining the currently saved program information at the client device are performed first with respect to the current version and then with respect to the next version.

12. The method as claimed in claim 11, wherein the client device obtains the delivered program information by requesting the delivered program information from the program information server.

13. The method as claimed in claim 12, wherein the program information server delivers the program information as Internet Protocol packets.

14. The method as claimed in claim 13, wherein the client device updates the currently saved program information of the current version upon receiving a new program information version and a new program information map from the program information server.

15. The method as claimed in claim 14, wherein the program information version is expressed by a timestamp.

16. A device for obtaining program information in digital video broadcasting, comprising:
a receiver for receiving program information from a program information server through Internet protocol, the program information including a program information version indicating a version status of the program information and a program information map including a set of information records used to allow the client device to identify a program to be delivered at the version status and to reproduce the program; and
a processor for updating currently saved program information at the client device when a version status included in the currently saved program information of the client device is different from the version status of the delivered program information, by obtaining the program information delivered from the program information server as new program information.

17. The device of claim 16, the processor is further used for retaining the currently saved program information at the client device when the version status included in the currently saved program information is the same as the version status of the delivered program information.

18. The device of claim 17,
wherein the version status includes a current version and a next version,
wherein the updating of the program information depending on a version change of the version status at the program information server is performed by updating the program information from the current version to the next version as time passes with respect to both the program information version and the program information map, and
wherein the updating of the currently saved program information at the client device and retaining the currently saved program information at the client device are performed first with respect to the current version and then with respect to the next version.

19. The device of claim 18, wherein the processor is further used for requesting the delivered program information from the program information server.

20. The device of claim 19, wherein the program information is delivered as Internet Protocol packets.

21. The device of claim 20, wherein the processor is further used for updating the currently saved program information of the current version upon receiving a new program information version and a new program information map from the program information server.

22. The device of claim 16, wherein the program information version is expressed by a timestamp.

23. A STB device comprising the device of claim 16.
